(19) United States
(12) Patent Application Publication
(10) Pub. No.: US 2007/0225014 A1
(43) Pub. Date: Sep. 27, 2007

(54) Radio communication system and radio communication terminal for the same

(75) Inventor: Kengo Kurose, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/496,819

(22) Filed: Aug. 1, 2006

(30) Foreign Application Priority Data
Mar. 24, 2006 (JP) 2006-084246

(51) Int. Cl. H04Q 7/20

(52) U.S. Cl. 455/452.2

(57) ABSTRACT

Mobile stations compare first evaluation function values calculated in self terminals with second evaluation function values notified from a base station through a notification message of a neighboring base station list for each base station by chunk, respectively, to determine whether first evaluation function values≧second evaluation function values is satisfied or not. Based on the determination results, the mobile station count the numbers Ca and Cb of the chunks in which it is determined that first evaluation function values≧second evaluation function values is established for each base station, respectively, and select a base station having a larger count value to transmit a CQI thereto.

### CROSS-REFERENCE TO RELATED APPLICATIONS

This application is based upon and claims the benefit of priority from prior Japanese Patent Application No. 2006-084246, filed Mar. 24, 2006, the entire contents of which are incorporated herein by reference.

### BACKGROUND OF THE INVENTION

1. Field of the Invention

The present invention relates to a radio communication system that employs an adaptive modulation scheme, and more particularly to a radio communication system equipped with a scheduler by which a base station selects a radio communication terminal at a communication destination in response to a communication request from a radio communication terminal and to a radio communication terminal for the same.

2. Description of the Related Art

A radio communication system that employs a so-called adaptive modulation and coding adaptively controlling a modulation scheme and a channel coding rate performs transmission control between a base station and a radio communication terminal as follows. That is, the radio communication terminal firstly measures reception qualities of downlinks of a plurality of neighboring base stations, respectively, to select a base station with the highest reception quality on the basis of the measured result. The communication system decides an available transmission format, i.e. a combination of the modulation scheme and the channel coding rate, under the reception quality of the downlink of the selected base station and transmits the decided transmission format as a channel quality indication (CQI) to the selected base station through an uplink. In response to this, the base station uses a dedicated channel for the communication terminal to changeover the modulation scheme and the channel coding rate of information data. In this manner, when transmitting the information data from the base station to the communication terminal through the dedicated channel, the base station becomes able to transmit the information data by using the high data rate that error resilience is low in the high SNR condition at the communication terminal, and in contrast, in the low SNR condition, it becomes possible to transmit the information data by using the low data rate that error resilience is high at the communication terminal.

To perform the forgoing transmission control, the communication terminal or the base station is provided with a table. The table stores a predicted down data communication rate by associating with the reception quality of the downlink. The predicted downlink data communication rate directly indicates an extremely accurate data communication rate corrected on the basis of, for instance, statistical data of an error rate of a predicted or past down data transmission. If the communication terminal is provided with the table, the communication terminal reads out the predicted down data communication rate corresponding to the down reception quality from the table to notify the communication rate to the base station. If the base station has the foregoing table, the base station reads out the predicted down data communication rate corresponding to the down reception quality toward the targeted radio communication terminal form the table, based on the CQI information transmitted from the radio communication terminal. As a result, data communication between the base station and the communication terminal is performed at the communication rate according to the reception quality of the down channel.

Incidentally, a service form of the communication system employing the aforementioned adaptive modulation and coding is generally a best-effort type. Therefore, the communication terminal requires a communication only with the base station having the best reception quality of the downlink. The base station transmits a packet of the information data on a preferential basis to a radio communication terminal excellent in reception quality of a downlink and requiring a high data rate. A terminal selecting (scheduling) algorithm by the base stain in this case is called a Maximum CIR(SNR). In the Maximum SNR, a radio communication terminal in the low SNR condition becomes to be placed a low priority to communicate with the base station.

A 1xEV-DO system which conforms to, for instance, technical specifications “C. S0024 cdma 2000 High Rate Packet Data Air Interface Specifications” presented by the standard-setting organization “3GPP2” employs a proportional fairness (PF) scheduler as a scheduler to eliminate the forgoing failure and enhance both throughput seen from the base station side and throughput seen from the radio communication terminal side while keeping balance there between. The PF scheduler takes a data quantity which was transmitted from the base station to the communication terminal in the past into account in addition to the reception quality of the downlink of the radio communication terminal (for instance, refer to IEEE international conference, VTC 2000 spring, announcement original copy, written by A. Japali, R. Padovani, and R. Pankaj, “Data throughput of CDMA-HDR a High Efficiently-High Data Rate Personal Communication Wireless System”).

For example, the base station calculates each evaluation function value “SNR_inst/SNR_ave” for each radio communication terminal. The “SNR_inst” is an instantaneous signal to noise ratio (SNR) of the downlink notified from the radio communication terminal to the base station. The “SNR_ave” is an averaged value of the SNRs of the downlink notified from the communication terminal to the base station in the past. By using such a scheduler, since the possibility of which the communication terminal, of which the downlink reception quality has become excellent, is selected, becomes higher, the communication system becomes able to reduce inequality of throughput for a reception environment among radio communication terminals.

However, since the conventional 1xEV-DO system gives weight the throughput between the radio communication terminal and the base station, the communication terminal transmits a communication request (CQI) to the base station with the best downlink reception quality. Therefore, even when the communication terminal is accessible to both a first station, such as a base station installed, for instance, at the front of a railroad station of which a large number of users always gather within the coverage area, and the second station, neighboring the first station of which only a relatively small number of users gather within the coverage area, the communication terminal always transmits a communication request to the first station if the reception quality from the first base station is better. Accordingly, the traffic of the first base station becomes higher, and this results in increased difficulty in making communications.

### BRIEF SUMMARY OF THE INVENTION

The present invention was arrived at by paying attention to the aforementioned situation, and an object of the invention is to provide a radio communication system and its radio communication terminal which enables transmitting a communication request to a base station with a high possibility of performing communications based on the traffic of each base station, thereby, to improve throughput of the whole communication system.

An aspect of the present invention provides the following configuration in a radio communication system equipped with a plurality of radio communication terminals transmitting a communication request to one of these base stations to make information communications with the one base station.

That is, at first each of the plurality of base stations has a means for selecting a radio communication terminal at a communication destination; a means for generating second determination conditions; and a determination condition transmitting means. The means for selecting the communication terminal at the communication destination generates first determination conditions at least on the basis of the communication qualities to and from the communication terminals for each radio communication terminal transmitted the communication request there from. Based on the first determination conditions generated for each communication terminal, the means for selecting the communication terminal selects the radio communication terminal at the communication destination. The means for generating the second determination conditions generates the second determination conditions with selection actual results of the communication terminals in a past prescribed time period reflected thereto. The determination condition transmission means transmits the generated second determination conditions to the plurality of the radio communication terminals.

On the other hand, each of the plurality of the communication terminals has a receiving means of determination conditions; a means for generating third determination conditions; a determination condition comparing means; and a base station selecting means. The determination condition receiving means receives the second determination conditions corresponding to each of the plurality of the base stations from at least one of them. The means for generating the third determination conditions uses an algorithm which has generated the first determination conditions to generate the third determination conditions at least on the basis of the communication qualities to and from the base stations for each base station. The determination condition comparing means compares the third determination conditions calculated for each base station to the received second determination conditions. The base station selecting means selects a base station adequate as a transmission destination of the communication request from among the plurality of the base stations, based on the comparison results of the determination conditions.

Accordingly, the communication terminal determines the level of a potential at which a self terminal is selected on the basis of the comparison results without depending only to the reception quality from the base station. Therefore, the communication terminal becomes possible to further appropriately selecting the base station with the traffic of the base station in mind, thus, it becomes possible to improve the throughput of the entire system.

That is to say, it becomes possible for the communication terminal to transmit the communication request to the base station having a higher possibility to always enable communicating by taking traffic for each base station into account, thus, the throughout of the whole of the communication system can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary schematic configuration view of a mobile communication system as a first embodiment of a radio communication system regarding the present invention;

FIG. 2 is an exemplary block diagram showing a configuration of a mobile station used in the communication system shown in FIG. 1;

FIG. 3 is an exemplary view showing an arrangement of subcarriers and chunks in an orthogonal frequency division multiplex (OFDM) system;

FIG. 4 is an exemplary view showing transmission/reception timing of control data and information data between a mobile station and a base station in the case of an application of a scheduling algorithm for a terminal selection to the OFDM system;

FIG. 5 is an exemplary view showing a configuration of an evaluation function value table provided for the mobile station shown in FIG. 2;

FIG. 6 is an exemplary flowchart showing a base station selection control procedure and its control content by the mobile station shown in FIG. 2;

FIG. 7 is an exemplary view showing an example of a comparison result of the evaluation function values in the mobile station shown in FIG. 2; and

FIG. 8 is an exemplary flowchart showing a base station selection control procedure and its control content by a mobile station regarding a second embodiment of the present invention.

### DETAILED DESCRIPTION OF THE INVENTION

### First Embodiment

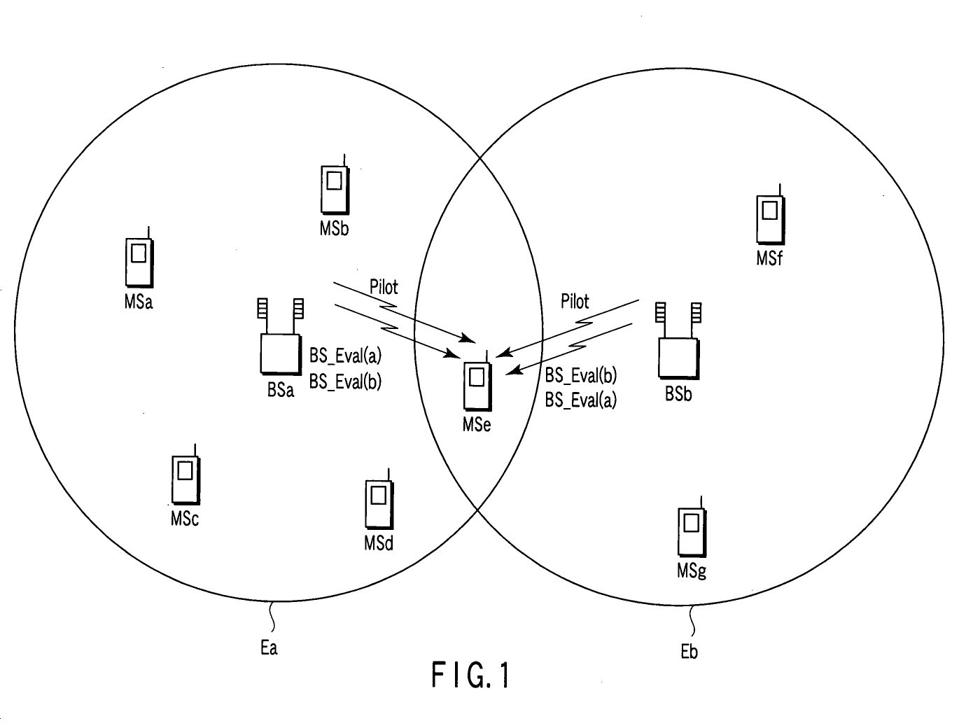

FIG. 1 is a schematic configuration view of the mobile communication system that is the first embodiment of the radio communication system regarding the present invention.

The communication system of the first embodiment dispersedly arranges a plurality of base stations BSa-BSn (only BSa and BSb are shown) in a service area. These base stations BSa-BSn form coverage areas Ea-En each called cells, respectively. The communication system connects the mobile stations MSa-MSg as radio communication terminals and the base stations BSa-BSn via radio channels in the coverage areas Ea-En to enable communications. The base stations BSa-BSn are connected to a control station (not shown) via cable channels and further connected to an upper rank network such as a cable subscriber network and the Internet from the control station.

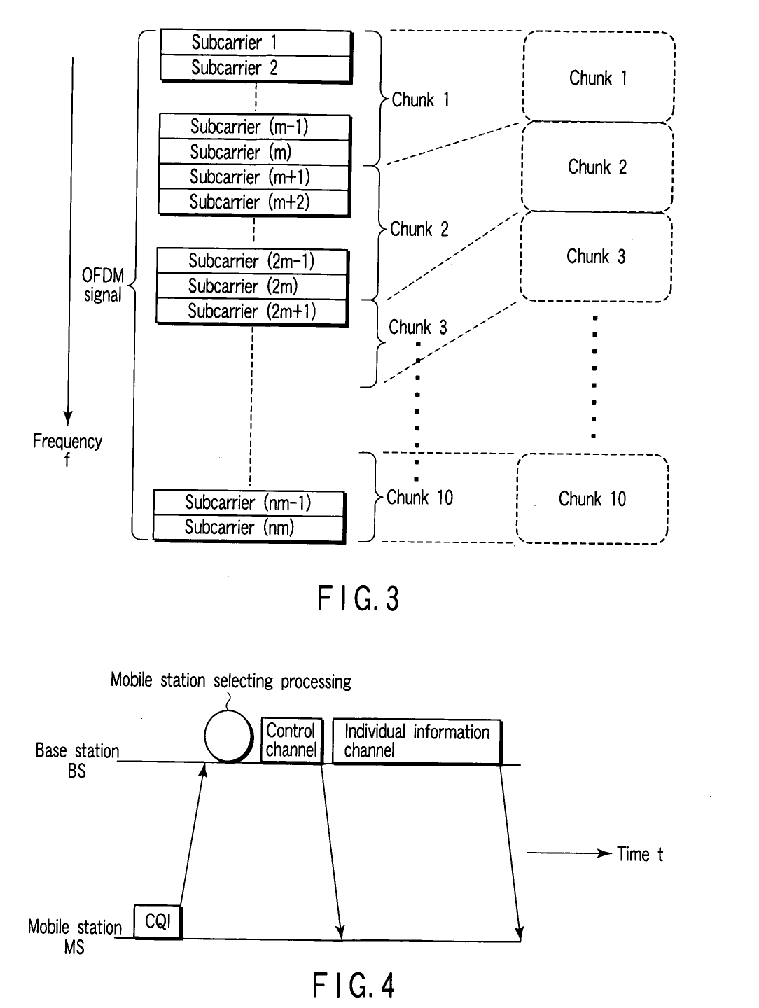

As for a radio access system among base stations BSA, BSb and the mobile stations MSa-MSg, an OFDM system is used. The OFDM system arranges, for instance, a number of subcarriers 1-(nm) in a frequency direction f as shown in FIG. 3. These subcarriers 1-(nm) are grouped for each m piece, thereby, a plurality of chunks 1-n are constituted. The subcarriers are assigned to the mobile stations MS1-MSg for each of the chunks 1-n. A single chunk is sometimes assigned to one mobile station, and a plurality of chunks are sometimes assigned to one mobile station simultaneously.

In such an OFDM system, if a scheduling algorithm for terminal-selecting, such as Maximum SNR or PF scheduler given below is employed, the mobile stations MSa-MSg measure radio transmission path qualities by each pilot signal for each chunk of the downlinks for each communicable base station BSa and BSb, respectively, to select the base station best in reception quality. The mobile stations MSa-MSb then transmit the measured results of the radio transmission qualities for each chunk as CQIs as shown in FIG. 4. On the other hand, the base stations BSa and BSb calculate the evaluation function values on the basis of the notified CQIs to decide the mobile stations to be assigned to the chunks in accordance with the scheduling algorithm. Then, the base stations BSa and BSb notify control channels of uplinks via control channels as shown in FIG. 4. The mobile stations MSa-MSg use the notified chunks and also receive the information data transmitted from the base stations BSa-Bsn in the notified transmission format in dedicated channels in accordance with the notified information.

Meanwhile, each base station BSa-BSn is provided with an evaluation function calculating unit to calculate the evaluation function values as the first determination conditions, a terminal selecting unit to select the radio communication terminal of the communication destination on the basis of the calculated evaluation function values in accordance with the scheduling algorithm, and an evaluation function notifying unit to calculate the evaluation function values as the second determination conditions and notify them to the mobile stations MSa-MSb, as the function regarding the present invention.

The evaluation function calculating unit calculates the evaluation function values as the first determination conditions for each mobile station MSa-MSb on the basis of the CQIs transmitted from the mobile station MSa-MSb. This calculation of the evaluation function values is performed for every chunk 1-10. The terminal selecting unit selects the radio communication terminal at the communication destination based on the calculated function values as the first determination conditions in accordance with the scheduling algorithm as mentioned above. As for the scheduling algorithm, both the Maximum SNR and the PF are available.

The maximum SNR, as given above, preferentially transmits the packet of the information data to the mobile station excellent in downlink reception quality and requiring a high data rate, and uses, for instance, the SNR_inst as the evaluation function. The better the reception quality of the downlink from the base station to the mobile station is, the larger the value of the SNR_inst becomes, and the maximum SNR selects the mobile station with the largest value of the SNR_inst.

The PF scheduler takes the averaged value of the reception qualities into account in addition to the reception qualities of the mobile stations as an index so that the base station selects the mobile station, and uses, for example, SNR_inst/SNR_ave as the evaluation function value. The further the down reception environment is improved, the larger the value of the SNR_inst/SNR_ave becomes, and the PF scheduler selects the mobile station with the highest value of the SNR_inst/SNR_ave.

The evaluation function notifying unit calculates an evaluation function value BS_Eval that is the second determination condition with the selected results on the mobile stations in a past predetermined time period reflected thereto for each chunk, based on the information indicating the selection results of the mobile stations MSa-MSg for chunk by the scheduling algorithm. The information indicating the evaluation function value BS_Eval for each calculated chunk is notified to each mobile station MSa-MSg by using the notification channels of the downlink. The evaluation function value BS_Eval to be notified may be a result in which the evaluation function value is best low, or may be an averaged value or a central value of all the mobile stations selected in a past predetermined time period.

The notifying means for the BS_Eval may be configured so that each base station BSa and BSb notify only the evaluation function values of their self stations, respectively, and so that the notifying means notifies the evaluation function values of the base stations described in a neighboring base station list altogether. In this case, if the notifying means notifies the evaluation function values by including the evaluation function values into notification messages of the existing neighboring base station list, it can reduce the signaling overhead of the notification channels in the downlink. The notifying means may notify a parameter having a potential for being varied by a parameter of a network, such as an evaluation function calculating algorithm and an averaged time constant necessary for calculating the SNR_ave together with the foregoing evaluation function values.

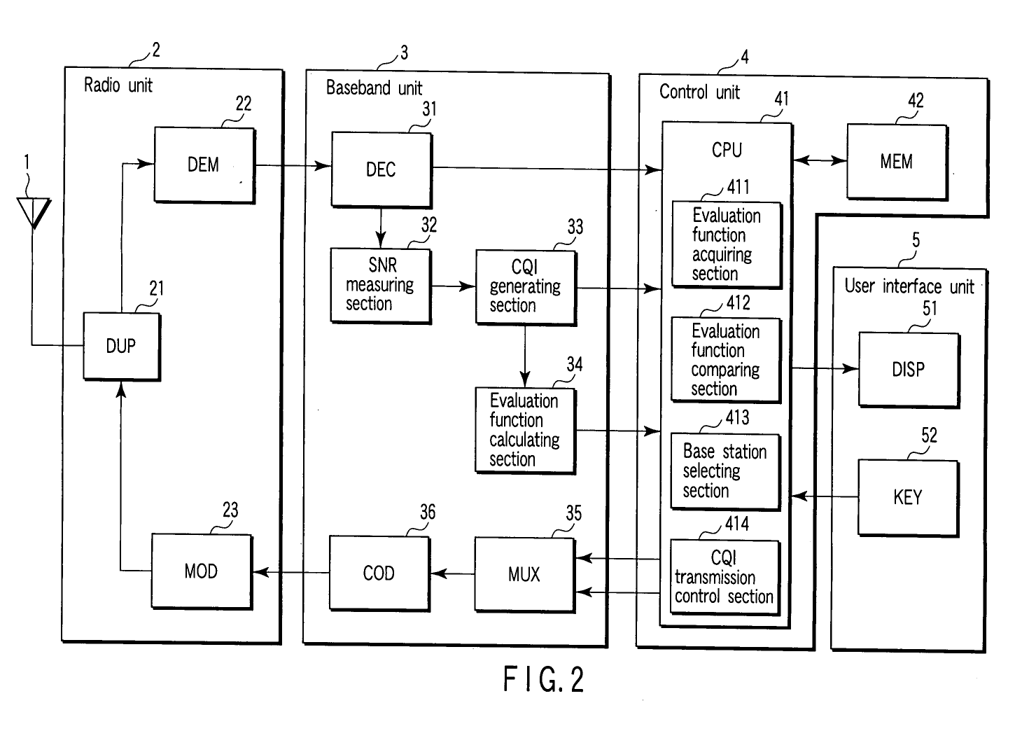

On the other hand, the mobile stations MSa-MSg are each configured as follows. FIG. 2 is a block diagram showing its functional configuration. Each mobile communication terminal MS1-MSg has an antenna 1, a radio unit 2, a baseband unit 3, a control unit 4, and a user interface unit 5.

The radio unit 2 includes an antenna duplexer (DUP) 21, a demodulation circuit (DEM) 22 and a modulation circuit (MOD) 23. Among them, the DEM 22 has a radio unit and a demodulating unit. The DEM 22 amplifies and filters a radio signal, received from the antenna 1, by the radio unit, then demodulates it by the demodulating unit. As for a demodulation scheme, for instance, an orthogonal demodulation scheme is used. The MOD 23 has a modulating unit and a radio unit. The MOD 23 modulates the radio signal by the modulating unit on the basis of the transmission signal output from the baseband unit 3, power-amplifies the modulated radio signal, and then, transmits it toward the base station from the antenna 1 through the DUP 21. As for the modulation scheme, the radio unit 2 prepares a plurality of modulation schemes differing in modulation efficiency, such as a quadrature phase shift keying (QPSK) system, an 8-phase shift keying (PSK) system, and a 16-quadrature amplitude modulation (QAM9) system. These modulation schemes are selectively used in response to communication qualities of transmission paths.

The baseband unit 3 has a decoder (DEC) 31, a SNR measuring unit 32, a CQI generating unit 33, an evaluation function value calculating unit 34, a multiplexer (MUX) 35 and a coder (COD) 36 as functions regarding the present invention. These functions of the baseband unit 3 are achieved by, for example, a digital signal processor (DSP).

The DEC 31 applies inverse spread processing on the demodulated signal output from the DEM 22, thereby, it reproduces a variety of received signals in the baseband.

The SNR measuring unit 32 calculates current signal to noise ratio SNR for each chunk calculated by the DEC 31.

The CQI generating unit 33 decides a transmission format by chunk available under the measured values of the SNRs, namely the combinations of the modulating systems and the channel coding rates for each base station BSa and BSb. For each base station BSa and BSb, the CQI generating unit 33 supplies the transmission formats decided by chunk to the control unit 4, as CQIs. The control unit 4 has a CQI table in a memory unit (MEM) 42. The control unit 4 stores CQIs by chunk decided for each base station BSa and BSb in the CQI table, respectively.

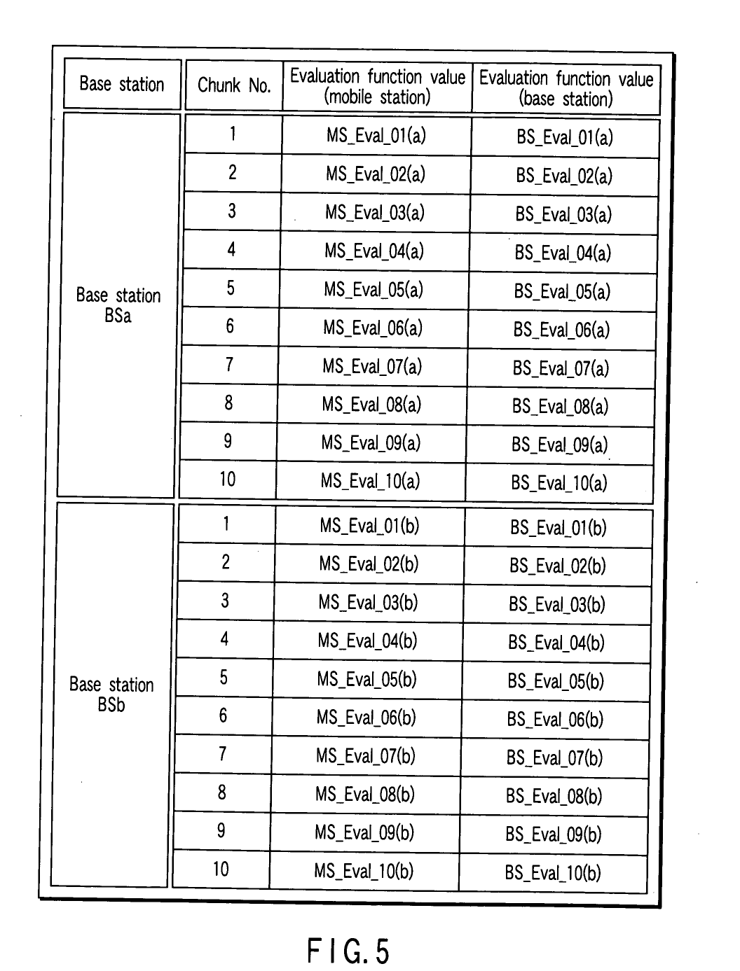

The evaluation function calculating unit 34 performs the following processing by using the same algorithm as calculating algorithms to be used by the aforementioned base stations BSa and BSb. That is, the calculating unit 34 firstly calculates evaluation function values MS_Eval(a) and MS_Eval(b) (third determination condition) for the base stations BSa and BSb by chunk, based on the SNRs by chunk calculated by the SNR measuring unit 32 for each base station BSa and BSb and the CQIs by chunk decided by the CQI generating unit 32 for each base station BSa and BSb. The control unit 4 has an evaluation function value table in the MEM 42. The control unit 4 stores evaluation function values MS_Eval_01(a) to MS_Eval_10(a) and MS_Eval_01(b) to MS_Eval_10(b) by chunk calculated for each base station BSa and BSb by the evaluation function calculating unit 34 in the evaluation function value table. FIG. 5 shows an example of the configuration of the evaluation function value table.

The multiplexer 35 multiplexes the CQIs and transmission data output from the control unit 4 to supply the multiplexed data to the COD 36. The COD 36 spreads the multiplexed data supplied from the multiplexer 35 by spreading codes to generate a transmission signal and supplies the generated transmission signal to the MOD 23 of the radio unit 2.

The user interface unit 5 includes a display unit (DISP) 51 and an operation unit (KEY) 52. The DISP 51 consists of, for instance, a liquid crystal display unit. The KEY 52 consists of a key pad having a dial key and a plurality of function keys.

The control unit 4 has a central processing unit (CPU) 41 and the MEM 42. The CPU 41 has an evaluation function acquiring unit 411, an evaluation function comparing unit 412, a base station selecting unit 413, and a CQI transmission control unit 414 as its control functions. These control functions are each realized by running a control program stored in the MEM 42 through the CPU 41.

The evaluation function acquiring unit 411 acquires evaluation function values BS_Eval_01(a) to BS_Eval_10(a) and BS_Eval_01(b) to BS_Eval_10(b) by chunk with the selected results of the mobile stations for the past prescribed time period notified at time periods longer than the transmission period of the CQIs from the base stations BSa and BSb.

At this moment, the base stations BSa and BSb each notify the evaluation function values of their self stations and the evaluation function values of the neighboring base stations by including them in a neighboring list message. For instance, as shown in FIG. 1, the base station BSa notifies the evaluation function values BS_Eval_01(a) to BS_Eval_10(a) of the self station and the evaluation function value BS_Eval(b) of the neighboring base station. The base station BSb notifies the BS_Eval(b) of the self station and the evaluation function values BS_Eval_01(b) to BS_Eval_10(b) of the neighboring base stations. Therefore, the mobile station MSe can acquire the evaluation function values of the plurality of base stations including the neighboring base stations by receiving the evaluation function value from either of the base station BSa or BSb.

The evaluation function acquiring unit 411 stores the acquired evaluation function values BS_Eval_01(a) to BS_Eval_10(a) and BS_Eval_01(b) to BS_Eval_10(b) in the evaluation function value table, as shown in FIG. 5. In the case in which the parameters such as a calculating algorithm of evaluation functions and an averaged time constant necessary for calculating the SNR_ave together with the evaluation function values BS_Eval_01(a) to BS_Eval_10(a) and BS_Eval_01(b) to BS_Eval_10(b) are notified from the base stations BSa and BSb, the acquiring unit 411 also stores the notified parameters in the function value table.

The evaluation function comparing unit 412 compares the evaluation function values MS_Eval_01(a) to MS_Eval_10(a) and MS_Eval_01(b) to MS_Eval_10(b) calculated by self terminal and the evaluation function values BS_Eval_01(a) to BS_Eval_10(a) and BS_Eval_01(b) to BS_Eval_10(b) acquired from the base station BSa by corresponding chunk for each base station BSa and BSb, respectively, to determine whether MS_Eval≧BS_Eval is satisfied or not.

The base station selecting unit 413 counts the number of chunks determined as MS_Eval≧BS_Eval for each base station BSa and BSb on the basis of the comparison results provided by the comparing unit 412. The selecting unit 413 then selects the base station with the larger count value as the base station of the CQI transmission destination.

The CQI transmission control unit 414 transmits the CQIs of the chunks determined as MS_Eval≧BS_Eval to the base station selected by the selecting unit 413. At this moment, the control unit 414 may select chunks by a prescribed number in the order of a larger value of MS_Eval-BS_Eval from among the chunks determined as MS_Eval≧BS_Eval to transmit the CQIs to the selected chunks.

Next, base station selection control operations in the mobile communication system configured as mentioned above will be described. Here, operations of the mobile station MSe shown in FIG. 1 will be explained as an example.

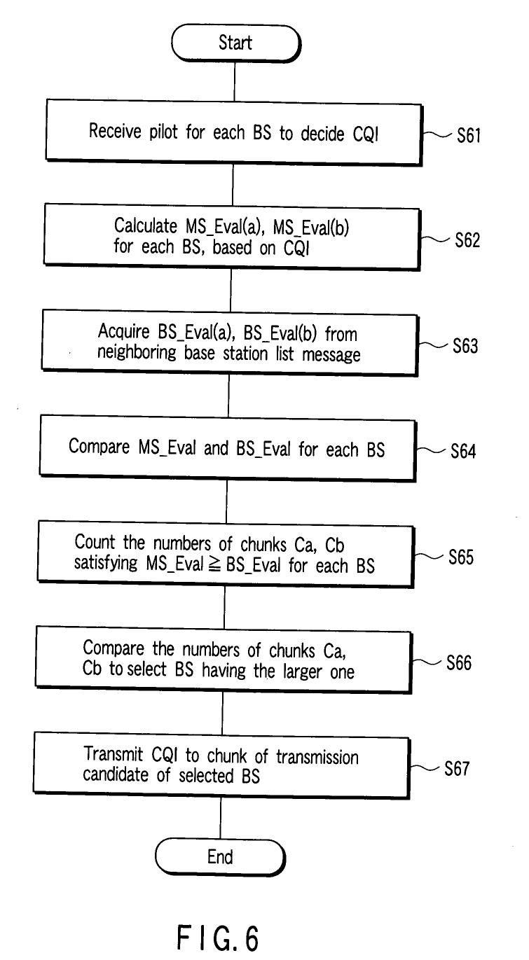

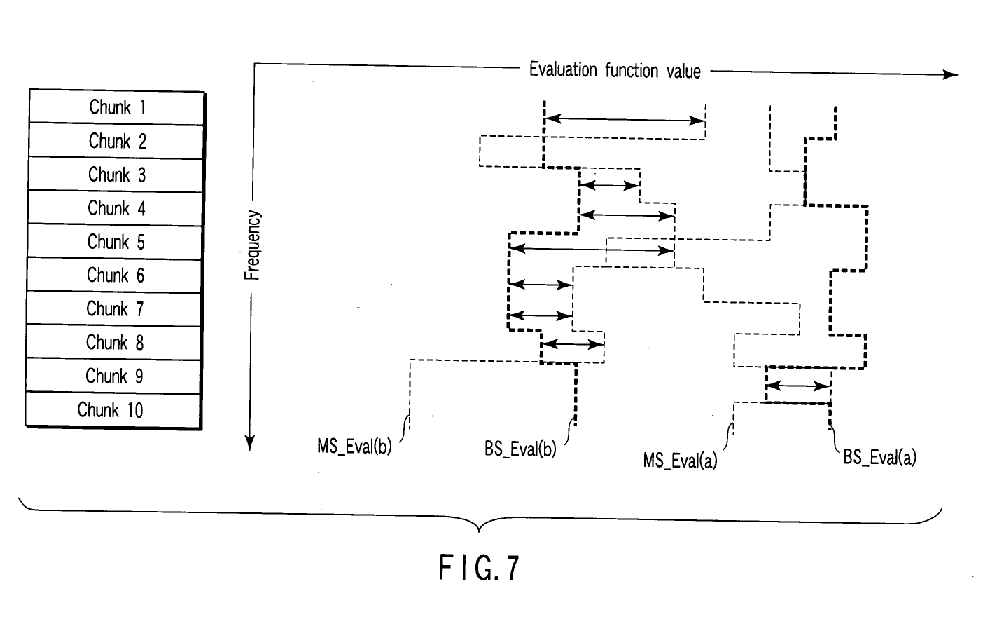

FIG. 6 is a flowchart showing a base station selection control procedure and a control content performed by the mobile station MSe, and FIG. 7 is a view showing an example of a comparison result of the evaluation function value in the mobile station MSe.

In a receiving period of a slot, in a step S61, the mobile station MSe firstly receives a pilot signal broadcasted for each chunk from the base stations NSa and BSb, respectively, to calculates the SNR. Based on the SNR by chunk calculated for each base station BSa and BSb, the SNR measuring unit 32 calculates the signal to noise ratio of SNR at the current receiving slot. The CQI generating unit 33 decides a transmission format available on the basis of the calculated SNR measured value, in other words, the combination of the modulation scheme and the channel coding rate by chunk for each base station BSa and BSb, to store the decided transmission format in the CQI table within the MEM 42.

Sequentially, the mobile station MSe shifts to a step S62 then the SNR measuring unit 32 calculates the evaluation function values MS_Eval(a) and MS_Eval(b) of the self terminal for the base stations BSa and BSb by chunk, based on the SNRs by chunk calculated by the SNR measuring unit 32 for each base station Sa and Sb and the CQIs by chunk decided by the CQI generating unit 33 for each base station BSa and BSb. The mobile MSe then, as shown in FIG. 5, stores the evaluation function values MS_Eval_01(a) to MS_Eval_10(a) and MS_Eval_01(b) to MS_Eval_10(b) by chunk calculated for each base station BSa and BSb in the evaluation function value table within the MEM 42.

Next, in a step S63, the mobile station MSe receives the notification message of the neighboring base station information list from the base station BSa to extract the evaluation function values BS_Eval_01(a) to BS_Eval_10(a) and BS_Eval_01(b) to BS_Eval_10(b) at the base stations BSa and BSb from the received message. And the mobile station MSe stores the extracted evaluation function values BS_Eval_01(a) to BS_Eval_10(a) and BS_Eval_01(b) to BS_Eval_10(b) in the evaluation function value table, as shown in FIG. 5. These evaluation function values BS_Eval_01(a) to BS_Eval_10(a) and BS_Eval_01(b) to BS_Eval_10(b) are values calculated by chunk, by the base stations BSa and BSb, respectively, so that the selection results of the mobile stations in a past prescribed time period are reflected thereto.

The mobile station MSe, then, in a step S64, compares the evaluation function values MS_Eval_01(a) to MS_Eval_10(a) and MS_Eval_01(b) to MS_Eval_10(b) calculated by the self terminals with the evaluation function values BS_Eval_01(a) to BS_Eval_10(a) and BS_Eval_01(b) to BS_Eval_10(b) acquired from the base station BSa for each base station BSa and BSb and also by chunk, respectively, to determine whether MS_Eval≧BS_Eval is satisfied or not. Next, based on the determination results given above, in a step S65, the mobile station MSe counts the numbers Ca and Cb of the chunks in which it is determined that MS_Eval≧BS_Eval is established for each base station BSa and BSb, respectively. Then, the mobile station MSe selects the base station having a larger count value Ca or Cb in a step S66. In a step S67, the mobile station MSe reads out the CQI of the chunk in which it is determined that MS_Eval≧BS_Eval is satisfied for the selected base station to transmit the read out CQI to the selected base station.

For example, it is presumed that the comparison result of the evaluation function values is as shown in FIG. 7. In this case, the number of chunks for which it is determined that MS_Eval≧BS_Eval is satisfied becomes seven for the base station BSb, while the number of chunks for which it is determined that MS_Eval≧BS_Eval is satisfied is one for the base station BSa. Therefore, in this case, although the absolute value of the evaluation function is smaller than that of the base station BSa, the base station BSb is selected and the CQIs of the seven chunks are transmitted to the base station BSb.

Incidentally, conventionally, the base station BSa having the decided high data rate of the CQI is unconditionally selected and the CQI is transmitted to the base station BSa. Therefore, as shown in FIG. 1, the mobile station MSe becomes to be assigned communications from the base station BSa with heavy traffic and results in a reduction in throughput.

As mentioned above, in the first embodiment, the mobile stations MSa-MSg compare the evaluation function values MS_Eval_01(a) to MS_Eval_10(a) and MS_Eval_01(b) to MS_Eval_10(b) calculated by the self terminals with the evaluation function values BS_Eval_01(a) to BS_Eval_10(a) and BS_Eval_01(b) to BS_Eval_10(b) notified from the base station BSa through the notification message of the neighboring base station information list for each base station BSa and BSb and also by chunk, respectively, to determine whether MS_Eval≧BS_Eval is satisfied or not. The mobile stations MSa-MSg then count the number of the chunks for which it is determined that MS_Eval≧BS_Eval is satisfied for each base stations BSa and BSb on the basis of the determined results to transmit the CQI by selecting the base station having larger count values Ca or Cb.

Accordingly, the mobile station MSe does not depend only on the reception qualities of the base stations BSa and BSb, but determines the level of the possibility in which the self terminal is selected on the basis of the compared result of the evaluation function values, and selects the base station, based on the determination result. Therefore, the mobile station MSe can perform a further appropriate selection of the base station while taking the traffic of the base station in account, thus, it can suppress the concentration of the traffic to the specific base station to improve the throughput of the whole communication system.

### Second Embodiment

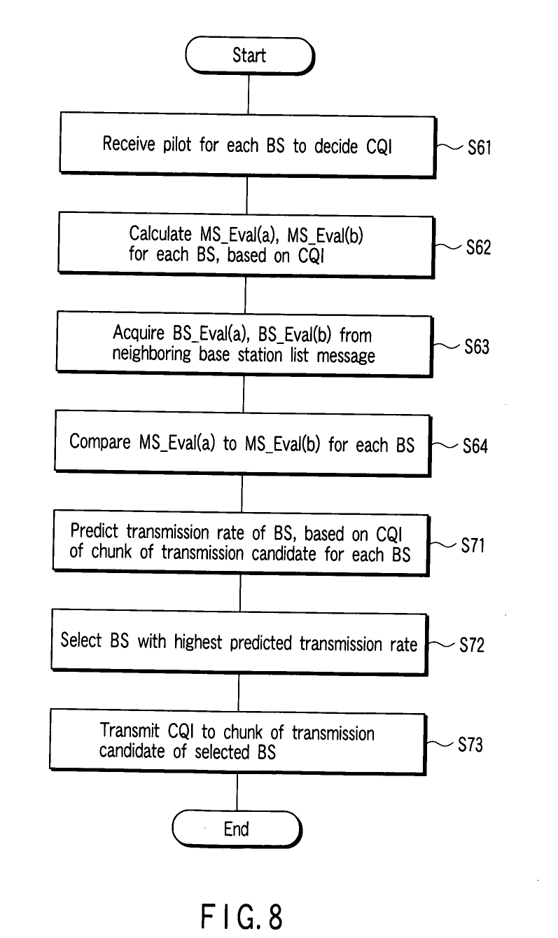

FIG. 8 is the flowchart showing the procedure of the base station selection control and the control content performed by the mobile station regarding the second embodiment. In FIG. 8, the same parts as those in FIG. 6 have the same reference symbols and their detailed descriptions will be omitted.

In the step S64, after completing comparison processing of the evaluation function values MS_Eval_01(a) to MS_Eval_10(a) and MS_Eval_01(b) to MS_Eval_10(b) calculated by the self terminals with the evaluation function values BS_Eval_01(a) to BS_Eval_10(a) and BS_Eval_01(b) to BS_Eval_10(b) acquired from the base station BSa, the mobile station MSe shifts to a step S71 sequentially. The mobile station MSe reads out the CQIs from the CQI table in the MEM 42 for the chunks for which it is determined that MS_Eval≧BS_Eval is satisfied by means of the comparison processing, and then predicts the transmission rates of the downlinks using the chunks on the basis of the read out CQIs. In a step S72, the mobile station MSe selects the base station, of which the predicted transmission rate is the highest one or faster than the threshold thereof. The mobile station MSe then specifies the chunk with the highest predicted transmission rate to transmit the CQIs to the selected base station.

Accordingly, the mobile station MSe selects the base station having a high possibility to select its self terminal on the basis of the comparison result of the evaluation function values and the predicted value of the transmission rate without depending only on the reception qualities from the base stations BSa and BSb. Therefore, the second embodiment can also perform a further appropriate selection of the base station while taking the traffic of the base station into account, thus, it can suppress the concentration of the traffic on the specific base station to improve the throughput of the whole communication system.

### Other Embodiment

In each of the embodiments, the mobile station MSe compares the evaluation function values MS_Eval_01(a) to MS_Eval_10(a) and MS_Eval_01(b) to MS_Eval_10(b) calculated by the self terminals with the evaluation function values BS_Eval_01(a) to BS_Eval_10(a) and BS_Eval_01(b) to BS_Eval_10(b) notified from the base station BSa as they are.

However, the evaluation function values BS_Eval_01(a) to BS_Eval_10(a) and BS_Eval_01(b) to BS_Eval_10(b) notified from the base stations BSa and BSb are the indexes acquired as the averaged value for the fixed time period, so that it is preferable to set offsets in order to compare them.

As for a setting method of offsets, for instance, a method for appropriately instructing the offsets from the base stations BSa and BSb, and a method for fixedly setting the offsets by the mobile stations MSa-MSg are possible choices. Among them, the method for appropriately instructing them from the base stations BSa and BSb may determine the size of dispersion generated on the evaluation function values by the base station on the basis of the calculation method of the evaluation function values to variably set offset values on the basis of the determination values of the dispersion so that the larger the size of the dispersion is, the larger the offset values are set.

Each of the embodiments transmits the CQIs to the selected base station for each chunk for which it is determined that MS_Eval≧BS_Eval is established. However, the present invention is not limited to those embodiments, if there are a plurality of chunks for which it is determined that MS_Eval≧BS_Eval is satisfied, acquiring an averaged value of the CQIs of the plurality of the chunks to transmit the averaged value of the CQIs through one chunk is a possible approach. In this manner, it becomes possible to reduce the signaling overhead of the uplink.

Furthermore, in the case of notifying the evaluation function values from the base station to the mobile station, the base station may acquire an averaged value or a central value of the evaluation function values for a plurality of chunks to transmit the averaged value and the central value of the evaluation function values. In such a way, the notification information amount of the evaluation functions may be reduced.

Further, the aforementioned embodiments having set the notification periods of the evaluation function values from the base stations to the mobile stations to the same period as the CQI transmission period, it is preferable to set the notification period to the period longer than the CQI transmission period. For instance, in the case of setting the CQI transmission period to around one msec, the notification period of the evaluation functions is set to, for instance, around several hundred msec corresponding to the notification period of the neighboring base station information list. In this manner, the increase in the signaling overhead of the downlink caused by the notification of the evaluation functions can be reduced as much as possible.

Moreover, in the foregoing embodiments, as shown in FIG. 6, after deciding the CQIs and calculating the evaluation function values for each base station in the steps S61 and S62, the evaluation function values are acquired from the base station in the step S63. However, the present invention is not limited to this; it is acceptable to firstly acquire the evaluation function values from the base station through the step S63 in accordance with the notification period in the neighboring base station information list, then, after this, to decide the CQIs and calculate the evaluation function values for each base station in the steps S61 and S62.

Furthermore, each aforementioned embodiment having included the notification of the evaluation function value BS_Eval from the base station to the mobile station in the message for notifying the neighboring base station list, if there are any message to be transmitted from the base station to the mobile station, such messages may be used for notifying the evaluation function value BS_Eval.

Other than this, it is possible to make a variety of modifications to implement the types of the configurations of the mobile stations and scheduling algorithms used by the base stations, the procedure of the CQI transmission control and its control content without departing from the aspect of the invention.

To put it briefly, the present invention is not limited to the aforementioned embodiments as they are, and in an implementation phase, this invention may be embodied in various forms without departing from the inventive concept thereof. Various types of the invention can be formed by appropriately combining a plurality of constituent elements disclosed in the foregoing embodiments. Some of the elements, for example, may be omitted from the whole of the constituent elements shown in the embodiments above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication system comprising:
a plurality of base stations; and
a plurality of radio communication terminals which transmit communication requests to one of the plurality of the base stations to perform information communications with the base station, wherein
each of the plurality of the base stations comprises:
means for generating first determination conditions on the basis of communication qualities to and from the radio communication terminals for each of the radio communication terminals which have transmitted the communication requests;
means for selecting radio communication terminals at communication destinations on the basis of the first determination conditions generated for each of the radio communication terminal;
means for generating second determination conditions with actual selection results of the radio communication terminals in a past predetermined period reflected thereto, and
means for transmitting the generated second determination conditions to the plurality of the radio communication terminals, and
each of the plurality of the radio communication terminals comprises:
means for receiving the second determination conditions corresponding to the plurality of the base stations, respectively, from at least one of the plurality of the base stations;
means for generating third determination conditions on the basis of communication qualities to and from the base stations for each base station by using an algorithm which has generated the first determination conditions;
means for comparing the calculated third determination conditions with the received second determination conditions for each base station; and
means for selecting a base station adequate as a transmission destination of the communication requests from among the plurality of the base stations on the basis of comparison results of the determination conditions.

2. The radio communication system according to claim 1, wherein the means for transmitting the second determination conditions integrally transmits the second determination conditions corresponding to the plurality of the base stations including a self base station and neighboring bas stations, respectively, by including them into a neighboring base station list.

3. The radio communication system according to claim 1, wherein the means for transmitting transmits a type of a scheduling algorithm from the base station to the radio communication terminal.

4. The radio communication system according to claim 3, wherein the scheduling algorithm is Maximum SNR or PF scheduler.

5. The radio communication system according to claim 4, wherein the means for transmitting transmits an average time constant for executing the PF scheduling algorithm.

6. The radio communication system according to claim 5, the means for transmitting instructs offsets from the base station to the radio communication terminal.

7. The radio communication system according to claim 1, wherein, when the means for selecting selects the radio communication terminals selectively assigns the radio communication terminals to a plurality of resource blocks prepared within a unit time,
means for selecting the base station comprises:
means for acquiring the number of resource blocks having high possibilities at which the base stations assign self radio communication terminals among the plurality of resource blocks on the basis of the comparison results of the determination conditions for each of the base stations; and
the means for selecting a base station adequate as a transmission destination of the communication requests from among the plurality of base stations on the basis of the number of the resource blocks acquired for each of the base stations.

8. The radio communication system according to claim 1, wherein, when the means for selecting the radio communication terminals selectively assigns the radio communication terminals to at least one resource block prepared within a unit time,
the means for selecting the base station comprises:
means for detecting resource blocks having high possibilities in which the base stations assign self radio communication terminals on the basis of the comparison results of the determination conditions;
means for predicting transmission rates by the detected resource blocks; and
means for selecting a base station adequate as a transmission destination of the communication requests from among the plurality of base stations on the basis of predicted values of the transmission rates.

9. A radio communication terminal used in a radio communication system, comprising a plurality of base stations; and a plurality of radio communication terminals which transmits communication requests to one of the plurality of the base stations to perform information communications with the base station, wherein each of the plurality of the base stations comprises means for generating first determination conditions on the basis of communication qualities to and from the radio communication terminals for each of the radio communication terminals which have transmitted the communication requests and for selecting radio communication terminals at communication destinations on the basis of the first determination conditions generated for each of the radio communication terminal; means for generating second determination conditions with actual selection results of the radio communication terminals in a past predetermined period reflected thereto; and means for transmitting the generated second determination conditions to the plurality of the radio communication terminal, comprising:
means for receiving the second determination conditions corresponding to the plurality of the base stations, respectively, from at least one of the plurality of the base stations;
means for generating third determination conditions at least on the basis of communication qualities to and from the base station for each base station by using an algorithm which has generated the first determination conditions;
means for comparing the calculated third determination conditions with the received second determination conditions for each base station; and
means for selecting a base station adequate as a transmission destination of the communication requests from among the plurality of the base stations on the basis of comparison results of the determination conditions.

10. The radio communication terminal according to claim 9, wherein, when the means for selecting the radio communication terminals selectively assigns the radio communication terminals to a plurality of resource blocks prepared within a unit time,
the means for selecting the base station comprises:
means for acquiring the number of resource blocks having high possibilities at which the base stations assign self radio communication terminals among the plurality of resource blocks on the basis of the comparison results of the determination conditions for each of the base stations; and
means for selecting a base station adequate as a transmission destination of the communication requests from among the plurality of base stations on the basis of the number of the resource blocks acquired for each of the base stations.

11. The radio communication terminal according to claim 9, wherein, when the means for selecting the radio communication terminals selectively assigns the radio communication terminals to at least one resource block prepared within a unit time,
the means for selecting the base station comprises:
means for detecting resource blocks having high possibilities in which the base stations assign self radio communication terminals on the basis of the comparison results of the determination conditions;
means for predicting transmission rates by the detected resource blocks; and
means for selecting a base station adequate as a transmission destination of the communication requests from among the plurality of base stations on the basis of predicted values of the transmission rates.

12. A radio communication method for a plurality of base stations and a plurality of radio communication terminals which transmit communication requests to one of the plurality of the base stations to perform information communications with the base station comprising the step of:
generating step of generating first determination conditions on the basis of communication qualities to the radio communication terminals from the base station for each of the radio communication terminals;
selecting step of selecting radio communication terminals on the basis of the first determination conditions generated for each of the radio communication terminal;
generating step of generating second determination conditions with actual selection results of the radio communication terminals in a past predetermined period;
transmitting step of transmitting the second determination conditions to the plurality of the radio communication terminals;
receiving step of receiving the second determination conditions corresponding to the plurality of the base stations, from at least one of the plurality of the base stations;
generating step of generating third determination conditions on the basis of communication qualities to from the base stations to the radio communication terminal for each base station by using an algorithm which has generated the first determination conditions;
comparing step of comparing the third determination conditions with the second determination conditions for each base station; and
selecting step of selecting a base station among the plurality of the base stations on the basis of comparison results of the determination conditions.

13. The radio communication method according to claim 12, wherein the transmitting step transmits a type of a scheduling algorithm from the base station to the radio communication terminal.

14. The radio communication method according to claim 13, wherein the scheduling algorithm is Maximum SNR or PF scheduler.

15. The radio communication method according to claim 14, wherein the transmitting step transmits an average time constant for executing the PF scheduling algorithm.

16. The radio communication method according to claim 14, wherein the second determination condition is best low, or an average value or a central value of all the radio communication terminals selected in a past predetermined time period.

17. The radio communication method according to claim 12, further comprising:
assigning step of assigning the radio communication terminal to a resource block;
acquiring step of acquiring the number of resource blocks having high possibilities at which the base stations assign self radio communication terminals among the plurality of resource blocks on the basis of the comparison results of the determination conditions for each of the base stations; and
selecting step of selecting a base station among the plurality of base stations on the basis of the number of the resource blocks acquired for each of the base stations.

18. The radio communication method according to claim 17, wherein the resource block is a chunk of OFDM system.

19. The radio communication method according to claim 17, further comprising;
detecting step of detecting resource blocks having high possibilities in which the base stations assign self radio communication terminals on the basis of the comparison results of the determination conditions;
predicting step of predicting transmission rates by the detected resource blocks; and
selecting step of selecting a base station adequate as a transmission destination of the communication requests from among the plurality of base stations on the basis of predicted values of the transmission rates.

20. The radio communication method according to claim 12, wherein the selecting selects a base station among the plurality of the base stations, if the third determination conditions is better than the second determination conditions.
